(19) United States
(12) Patent Application Publication
(10) Pub. No.: US 2023/0305150 A1
(43) Pub. Date: Sep. 28, 2023

(54) ADAPTIVE SEARCH METHOD FOR LIGHT SPOT POSITIONS, TIME OF FLIGHT DISTANCE MEASUREMENT SYSTEM, AND DISTANCE MEASUREMENT METHOD

(71) Applicant: ORBBEC INC., Shenzhen (CN)

(72) Inventors: Xuan MA, Shenzhen (CN); Zhaomin WANG, Shenzhen (CN); Xing ZHOU, Shenzhen (CN); Liang ZHU, Shenzhen (CN); Jian SU, Shenzhen (CN); Ran HE, Shenzhen (CN); Yuanhao HUANG, Shenzhen (CN); Zhenzhong XIAO, Shenzhen (CN)

(21) Appl. No.: 18/202,498

(22) Filed: May 26, 2023

Related U.S. Application Data
(63) Continuation of application No. PCT/CN2021/106030, filed on Jul. 13, 2021.

(30) Foreign Application Priority Data
Mar. 1, 2021 (CN) 202110227556.4

(51) Int. Cl. G01S 17/10; G01S 7/481; G01S 7/497; G01S 7/4865

(52) U.S. Cl. CPC G01S 17/10; G01S 7/4815; G01S 7/4816; G01S 7/4865; G01S 7/497

(57) ABSTRACT

A method for search of light spot positions, includes the following steps: calibrating spatial template distribution of light spots in an object space of a distance measurement system and spatial emission angle factors of the light spots; calculating coordinates of offset light spots on a pixel unit of a collector after impact deformation occurs in the distance measurement system, and obtaining serial numbers of the offset light spots; and according to the coordinates of the offset light spots on the pixel unit of the collector and the serial numbers, calibrating the distance measurement system after the impact deformation occurs to obtain new spatial emission angle factors, and completing the search of light spot positions.

### CROSS REFERENCE TO RELATED APPLICATIONS

This application is a Continuation Application of International Patent Application No. PCT/CN2021/106030 filed with the China National Intellectual Property Administration (CNIPA) on Jul. 13, 2021, which is based on and claims priority to and benefits of Chinese Patent Application No. 202110227556.4, filed on Mar. 1, 2021. The entire content of all of the above-referenced applications is incorporated herein by reference.

### TECHNICAL FIELD

This application relates to technical fields of time-of-flight distance measurement, and in particular, to a method for adaptive search of light spot positions, a time-of-flight distance measurement system, and a distance measurement method.

### BACKGROUND

The time-of-flight (TOF) principle can be used to measure the distance from the target to obtain a depth image containing a target depth value, and the distance measurement system based on the time-of-flight principle has been widely applied to fields such as consumer electronics, autonomous vehicles, and AR/VR.

The distance measurement system based on the time-of-flight principle generally includes an emitter and a collector. The emitter is used for emitting pulsed beams to illuminate a target field of view, and the collector is used for collecting reflected beams. The time of flight of the beams from the emission to the received reflection is calculated to calculate the distance from the object. The emitter includes a light source, an emission optical element, and the like. The pulsed beams emitted by the light source are transmitted through the emission optical element (including a lens, a diffractive optical element, or the like) and projected onto the object space to form light spots with a fixed spatial template. The fixed spatial template of the light spots in the object space determines the specific measurement points on the surface of the measured object, and the specific parameters that determine the positions of the light spots include a spatial position of the light source, distortion of the lens, a spatial position of the lens, diffraction parameters of the diffractive optical element, a spatial position of the diffractive optical element, and the like.

The light spots with a fixed spatial template projected onto the surface of the measured object in the object space are reflected to the collector of the distance measurement system, the reflected light spots with another spatial template are formed on a pixel unit of the collector, and the pixel unit in the collector collects photons in the reflected light spots to form a photon detection signal. The fixed spatial template distribution of the light spots in the object space and on the pixel unit needs to be calibrated before leaving the factory, to obtain emission angles of the light spots in the object space and imaging positions of the reflected light spots on the pixel unit. The emission angles and the imaging positions determine whether the distance measurement system can accurately restore the three-dimensional point cloud image and accurately gate the pixels to collect the photons in the reflected light spots.

Although the fixed template distribution of the light spots in the object space and the fixed template distribution of the reflected light spots on the pixel unit have been calibrated when the system leaves the factory, in practical applications, the occurrence of thermal impact or force impact causes changes in the device parameters that determine the fixed template distribution of the light spots, and then the fixed template distribution of the light spot in the object space and on the pixel unit is changed. Finally, the distance measurement system fails to measure the information about a time of flight of light, or the three-dimensional point cloud restored by the time of flight of light is inaccurate.

### SUMMARY

This application provides an adaptive search method for light spot positions, a time-of-flight distance measurement system, and a distance measurement method, to resolve at least one of the problems in BACKGROUND.

To achieve the foregoing objective, the technical solutions in embodiments of this application are implemented as follows.

In a first aspect, a system for time-of-flight distance measurement includes: an emitter, configured to project pulsed beams to a target region that are reflected by the target region to form light spots; a collector, including a pixel unit including a plurality of pixels, and configured to receive the light spots; and a processing circuit, synchronizing trigger signals of the emitter and the collector, and processing photonic signals in the light spots, to calculate distance information of a target in the target region, where the collector further includes a memory and a first processing circuit; the memory is configured to store serial numbers of the light spots during system calibration, and spatial emission angle factors of the light spots with different serial numbers; the first processing circuit is configured to calculate coordinates of offset light spots after impact deformation occurs in the system, and obtain serial numbers of the offset light spots; and the processing circuit calibrates the system after the impact deformation occurs, according to the coordinates of the offset light spots and the serial numbers of the offset light spots, to obtain new spatial emission angle factors.

In some embodiments, the first processing circuit is configured to calculate the coordinates of the offset light spots after the impact deformation occurs according to the following formulas,

$$\begin{matrix}{{u}^{′}}_{i} = \\ \frac{{R}_{10} + {R}_{11} {u}_{i} + {R}_{12} {v}_{i} + {R}_{13} {u}_{i} {v}_{i} + {R}_{14} {u}_{i} {}^{2} + {R}_{15} {v}_{i} {}^{2} + {R}_{16} {u}_{i} {}^{2} {v}_{i} + {R}_{17} {v}_{i} {}^{2} u + {R}_{18} {u}_{i} {}^{3} + {R}_{19} {v}_{i} {}^{3}}{{\left(1 + {R}_{31} {u}_{i} + {R}_{32} {v}_{i}\right)}^{3}}\end{matrix}$$

$$\begin{matrix}{{v}^{′}}_{i} = \\ \frac{{R}_{20} + {R}_{21} {u}_{i} + {R}_{22} {v}_{i} + {R}_{23} {u}_{i} {v}_{i} + {R}_{24} {u}_{i} {}^{2} + {R}_{25} {v}_{i} {}^{2} + {R}_{26} {u}_{i} {}^{2} {v}_{i} + {R}_{27} {v}_{i} {}^{2} u + {R}_{28} {u}_{i} {}^{3} + {R}_{29} {v}_{i} {}^{3}}{{\left(1 + {R}_{31} {u}_{i} + {R}_{32} {v}_{i}\right)}^{3}}\end{matrix}$$

where (uᵢ, vᵢ) are coordinates of the light spots before the impact deformation occurs in the system, (u′i, v′ᵢ) are coordinates of the offset light spots after the impact deformation occurs, i is the serial number of the light spots or the offset light spots, Rₘₙ is a positional parameter, and m and n are integers.

In some embodiments, the processing circuit is configured to turn on a portion of light sources of the emitter, and determine coordinates of offset light spots on the pixel unit, and the first processing circuit is configured to obtain serial numbers of the offset light spots on the pixel unit according to a correspondence between the serial numbers of the light spots and the light sources.

In some embodiments, the processing circuit includes a second processing circuit, configured to control a bias voltage of pixels corresponding to the coordinates of the offset light spots on the pixel unit, activate the pixels to collect photons in the offset light spots on the pixel unit, and to output a photon detection signal.

In some embodiments, the light source includes a VCSEL array light source.

Another technical solution of the embodiments of this application are as follows.

In a second aspect, a method for search of light spot positions includes the following steps. S1: Calibrate spatial template distribution of light spots in an object space of a distance measurement system and spatial emission angle factors of the light spots. S2: Calculate coordinates of offset light spots on a pixel unit of a collector after impact deformation occurs in the distance measurement system, and obtain serial numbers of the offset light spots. S3: According to the coordinates of the offset light spots on the pixel unit of the collector and the serial numbers, calibrate the distance measurement system after the impact deformation occurs to obtain new spatial emission angle factors, and complete the search of light spot positions.

In some embodiments, in step S1, a calibration plate is placed in front of the distance measurement system, an emitter is controlled to project pulsed beams onto the calibration plate that are reflected by the calibration plate to form light spots, and a camera is used to photograph the calibration plate. The method further includes identifying and numbering the light spots, and calculating the spatial emission angle factors of the light spots with different serial numbers and the spatial template distribution of the light spots in the object space.

In some embodiments, in step S2, coordinates of the offset light spots on the pixel unit of the collector are calculated according to the following formulas,

$$\begin{matrix}{{u}^{′}}_{i} = \\ \frac{{R}_{10} + {R}_{11} {u}_{i} + {R}_{12} {v}_{i} + {R}_{13} {u}_{i} {v}_{i} + {R}_{14} {u}_{i} {}^{2} + {R}_{15} {v}_{i} {}^{2} + {R}_{16} {u}_{i} {}^{2} {v}_{i} + {R}_{17} {v}_{i} {}^{2} u + {R}_{18} {u}_{i} {}^{3} + {R}_{19} {v}_{i} {}^{3}}{{\left(1 + {R}_{31} {u}_{i} + {R}_{32} {v}_{i}\right)}^{3}}\end{matrix}$$

$$\begin{matrix}{{v}^{′}}_{i} = \\ \frac{{R}_{20} + {R}_{21} {u}_{i} + {R}_{22} {v}_{i} + {R}_{23} {u}_{i} {v}_{i} + {R}_{24} {u}_{i} {}^{2} + {R}_{25} {v}_{i} {}^{2} + {R}_{26} {u}_{i} {}^{2} {v}_{i} + {R}_{27} {v}_{i} {}^{2} u + {R}_{28} {u}_{i} {}^{3} + {R}_{29} {v}_{i} {}^{3}}{{\left(1 + {R}_{31} {u}_{i} + {R}_{32} {v}_{i}\right)}^{3}}\end{matrix}$$

where (uᵢ, vᵢ) are coordinates of the light spots before the impact deformation occurs, (u′ᵢ, v′ᵢ) are coordinates of the offset light spots after the impact deformation occurs, i is the serial number of the light spots or the offset light spots, Rₘₙ is a positional parameter, and m and n are integers.

In some embodiments, in step S2, a portion of light sources of the emitter is controlled to be turned on, and coordinates of the offset light spots on the pixel unit are determined, for the first processing circuit to obtain the serial numbers of the offset light spots according to a correspondence between the serial numbers of the light spots and the light sources.

Another technical solution of the embodiments of this application are as follows.

In a third aspect, a method for distance measurement includes the following steps: S60. Control an emitter to emit pulsed beams towards a target region, and a portion of the pulsed beams is reflected and incident on a sensing region in a collector to form light spots, where the sensing region includes at least one pixel unit, and the pixel unit includes a plurality of pixels. S61. Control the sensing region in the collector to collect photons in the light spots and output a photon detection signal, where the sensing region is a pre-calibrated initial sensing region. S62. Determine whether a center position of the light spots is the same as a position of the pre-calibrated initial sensing region, and if determining that the center position of the light spots is not the same as the position of the initial sensing region, determine a position of a second sensing region corresponding to the light spots through the search method for light spots according to the foregoing embodiments, and activate the second sensing region to collect the photons in the light spots, to output the photon detection signal. S63. Receive the photon detection signal to form a photon detection event signal, form a histogram based on the photon detection event signal, and further calculate distance information according to the histogram.

A time-of-flight distance measurement provided in an embodiment of this application includes: an emitter, configured to project pulsed beams to a target region that are reflected by the target region to form light spots; a collector, including a pixel unit composed of a plurality of pixels, and configured to receive the light spots; and a processing circuit, synchronizing trigger signals of the emitter and the collector, and processing photonic signals in the light spots, to calculate distance information of a target in the target region, where the collector further includes a memory and a first processing circuit; the memory is configured to store serial numbers of light spots during system calibration, and spatial emission angle factors of the light spots with different serial numbers; the first processing circuit is configured to calculate coordinates of offset light spots after impact deformation occurs in the system, and obtain serial numbers of the offset light spots; and the processing circuit calibrates the system after the impact deformation occurs, according to the coordinates of the offset light spots and the serial numbers of the offset light spots, to obtain new spatial emission angle factors. According to this application, an accurate light spot emission angle factor and an accurate imaging position are obtained by searching the light spot positions, so that the system is not affected by impact deformation such as thermal impact and force impact, thereby improving distance measurement accuracy.

### BRIEF DESCRIPTION OF THE DRAWINGS

To describe the technical solutions in the embodiments of this application or the existing technologies more clearly, the following briefly describes the accompanying drawings required for describing the embodiments or the existing technologies. Apparently, the accompanying drawings in the following description show only some embodiments of this application, and a person of ordinary skill in the art may derive other drawings from the accompanying drawings without creative efforts.

FIG. 1 is a schematic diagram of the principle of a distance measurement system, according to an embodiment of this application.

FIG. 2 is a structural diagram of a pixel unit of a distance measurement system, according to an embodiment of this application.

FIG. 3 is a flow chart that schematically illustrates a method for searching light spot positions, according to an embodiment of this application.

FIG. 4 is a schematic diagram of initial system calibration of a distance measurement system, according to an embodiment of this application.

FIG. 5 is a schematic diagram of light spots before and after impact deformation occurs in a distance measurement system, according to an embodiment of this application.

FIG. 6 is a flow chart that schematically illustrates a distance measurement method, according to an embodiment of this application.

### DETAILED DESCRIPTION

To make the technical problems to be resolved by the technical solutions, and the advantageous effects of the embodiments of this application clearer and more comprehensible, the following further describes this application in detail with reference to the accompanying drawings and embodiments. It is to be understood that the embodiments described herein are merely used for explaining this application but do not limit this application.

It is to be noted that, when an element is described as being “fixed on” or “disposed on” another element, the element may be directly located on the another element, or indirectly located on the another element. When an element is described as being “connected to” another element, the element may be directly connected to the another element, or indirectly connected to the another element. In addition, the connection may be used for fixation or circuit connection.

It should be understood that orientation or position relationships indicated by the terms such as “length”, “width”, “above”, “below”, “front”, “back,” “left”, “right”, “vertical”, “horizontal”, “top”, “bottom”, “inside”, and “outside” are based on orientation or position relationships shown in the accompanying drawings, and are used only for ease and brevity of illustration and description of embodiments of this application, rather than indicating or implying that the mentioned apparatus or component needs to have a particular orientation or needs to be constructed and operated in a particular orientation. Therefore, such terms should not be construed as limiting this application.

In addition, the terms “first” and “second” are used merely for the purpose of description, and shall not be construed as indicating or implying relative importance or implying a quantity of indicated technical features. In view of this, a feature defined by “first” or “second” may explicitly or implicitly include one or more features. In descriptions of the embodiments of this application, “a plurality of” means two or more, unless otherwise definitely and specifically limited.

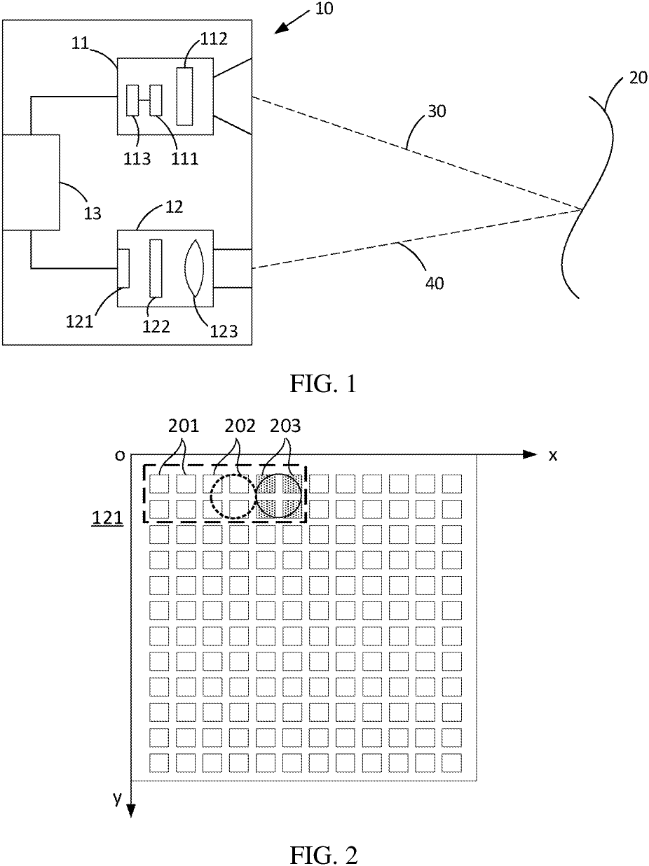

FIG. 1 is a schematic diagram of a time-of-flight distance measurement system, according to an embodiment of this application. The time-of-flight distance measurement system 10 includes an emitter 11, a collector 12, and a processing circuit 13. The emitter 11 includes a light source 111 includes one or more lasers, and is configured to emit pulsed beams 30 to a target 20, and at least a portion of the pulsed beams is reflected by the target to form reflected beams 40 back to the collector 12. The collector 12 includes a pixel unit 121 composed of a plurality of pixels, and is configured to collect photons in the reflected light beams 40 and output a photon detection signal. The processing circuit 13 synchronizes trigger signals of the emitter 11 and the collector 12 to calculate a time of flight of the photons in the beams from the emission to the received reflection back and a distance value of a to-be-measured target from the time-of-flight distance measurement system 10.

The emitter 11 includes the light source 111, an emission optical element 112, a driver 113, and the like. In an embodiment, the light source 111 is a VCSEL array light source chip formed by generating a plurality of VCSEL (Vertical Cavity Surface Emitting Laser) light sources on a single semiconductor substrate. The light source 111 can emit pulsed beams at a certain frequency (pulse period) under control of the processing circuit 13, and the pulsed beams are projected onto a target scene through the emission optical element 112 to form illumination spots (that is, light spots), where the frequency is set according to a measured distance.

The collector 12 includes the pixel unit 121, a filter unit 122, a receiving optical element 123, and the like. The receiving optical element 123 images the spot beams reflected by the target onto the pixel unit 121. The pixel unit 121 includes a plurality of pixels for collecting photons, and the pixel may be one of single photon devices for collecting photons, such as an APD (avalanche photodiode), an SPAD (single photon avalanche diode), and an SiPM (silicon photomultiplier tube). An event that the pixel unit 121 collects photons is regarded as occurrence of a photon detection event and a photon detection signal is outputted.

In an embodiment, the pixel unit 121 includes a plurality of SPADs, and the SPADs can respond to an incident single photon and output a photon detection signal indicating a corresponding the time of arrival of received photons at each SPAD. Generally, the collector 12 further includes a readout circuit (not shown in the figure) includes one or more of devices such as a signal amplifier, a time-to-digital converter (TDC), and an analog-to-digital converter (ADC) connected to the pixel unit. The readout circuit can be integrated with the pixels as a part of the collector or as a part of the processing circuit 13.

The processing circuit 13 synchronizes trigger signals of the emitter 11 and the collector 12, and is configured to process the photon detection signal outputted by the pixels collecting the photons, calculate a time of flight of the photons from the emission to the received reflection back, and further calculate distance information of the target. In some embodiments, the processing circuit 13 may be an independent dedicated circuit, such as a dedicated SOC chip, FPGA chip, or ASIC chip, or may include a general purpose processing circuit.

FIG. 2 shows an example of light spots offsetting on the pixel unit of the collector. The pixel unit 121 includes a plurality of pixels 201. When the distance measurement system is affected by factors such as thermal impact and force impact (hereinafter collectively referred to as impact deformation), positions of the light spots on the pixel unit change, and the light spots offset on the pixel unit. As shown by a dotted circle in FIG. 2, the light spots are no longer incident to a pre-calibrated sensing region 203, but incident to a sensing region 202 in an inactive state. The pixels in the sensing region 203 fail to collect photons in reflected light spots reflected back from a field of view and output an invalid interference signal, resulting in deviation of a distance value of the point in the target field of view corresponding to the sensing region 203 finally calculated by the processing circuit.

In an embodiment, the readout circuit of the collector includes a memory and a first processing circuit. The memory is configured to store serial numbers of light spots during system calibration and spatial emission angle factors (nₓ,ᵢ, n_{y},ᵢ, n_{z,i}) of the light spots with different serial numbers (that is, store a correspondence between the serial numbers of the light spots and the light sources of the emitter), and the first processing circuit is configured to calculate coordinates of the offset light spots after the impact deformation occurs in the system, to obtain positions of the offset light spots.

For example, the first processing circuit calculates coordinates (u′ᵢ, v′ᵢ) of the offset light spots according to the following formulas, where

$$\begin{matrix}{{u}^{′}}_{i} = \\ \frac{{R}_{10} + {R}_{11} {u}_{i} + {R}_{12} {v}_{i} + {R}_{13} {u}_{i} {v}_{i} + {R}_{14} {u}_{i} {}^{2} + {R}_{15} {v}_{i} {}^{2} + {R}_{16} {u}_{i} {}^{2} {v}_{i} + {R}_{17} {v}_{i} {}^{2} u + {R}_{18} {u}_{i} {}^{3} + {R}_{19} {v}_{i} {}^{3}}{{\left(1 + {R}_{31} {u}_{i} + {R}_{32} {v}_{i}\right)}^{3}} \\ {{v}^{′}}_{i} = \\ \frac{{R}_{20} + {R}_{21} {u}_{i} + {R}_{22} {v}_{i} + {R}_{23} {u}_{i} {v}_{i} + {R}_{24} {u}_{i} {}^{2} + {R}_{25} {v}_{i} {}^{2} + {R}_{26} {u}_{i} {}^{2} {v}_{i} + {R}_{27} {v}_{i} {}^{2} u + {R}_{28} {u}_{i} {}^{3} + {R}_{29} {v}_{i} {}^{3}}{{\left(1 + {R}_{31} {u}_{i} + {R}_{32} {v}_{i}\right)}^{3}}\end{matrix} \qquad \text{(1)}$$

where (uᵢ, vᵢ) are coordinates of the initial light spots before the impact deformation occurs in the distance measurement system, i is the serial number of the light spot, and Rₘₙ is a positional parameter.

The positional parameter Rₘₙ can be calculated according to the above formula (1) through a plurality of point pairs of correspondences between the offset light spots and the initial light spots (i takes different values). After the positional parameter Rₘₙ is determined, coordinates (uᵢ, vᵢ) of all the initial light spots are substituted into the above formula, and the coordinates (u′ᵢ, v′ᵢ) of all the offset light spots can be obtained.

In an embodiment, the processing circuit controls a portion of the light sources of the emitter to be turned on (for example a column or a row), and the first processing circuit is further configured to determine positions of the offset light spots on the pixel unit according to the correspondence between the serial numbers of the light spots and the light sources to obtain serial numbers of the offset light spots. It may be understood that when impact deformation occurs, offsets of the light spots in the same column or row are basically the same.

In an embodiment, the processing circuit calibrates the distance measurement system in which the impact deformation occurs, according to the coordinates (u′ᵢ, v′ᵢ) of the offset light spot and the serial number i of the light spot to obtain new spatial emission angle factors (n′_{x,i}, n′_{y,i}, n′_{z,i)}.

In an embodiment, the processing circuit includes a second processing circuit. After the positions of the offset light spots are determined, the second processing circuit is configured to control a bias voltage of the pixels corresponding to the positions of the offset light spots, and activate the pixels to collect photons in the light spots, to output a photon detection signal. When the bias voltage of the pixels is greater than an avalanche voltage, the pixels are in an active state, and may be used for receiving photons in the reflected beams.

In an embodiment, the second processing circuit may be configured as an excess bias control circuit. According to the positions of the offset light spots, the second processing circuit adjusts the excess bias voltage on the pixels corresponding to the positions of the offset light spots to be greater than zero until the bias voltage is greater than the avalanche voltage, so that the pixels are in an active state, to collect photons in the light spots output a photon detection signal.

In an embodiment, a special pixel structure can also be set to control activation and deactivation of the pixels. For example, a storage unit is arranged in the pixels to store a control logic that controls the activation or deactivation of each pixel. According to the positions of the offset light spots, the processing circuit adjusts the execution of the control logic in the storage unit on the corresponding pixels to adjust the bias voltage applied to the pixels.

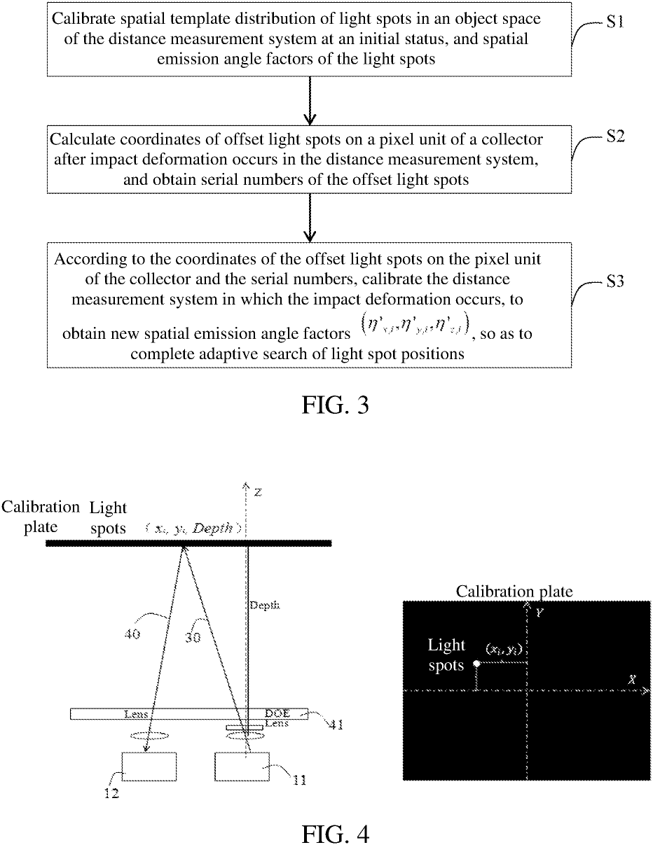

FIG. 3 shows an adaptive search method for light spot positions, according to another embodiment of this application. The method includes the following steps.

S1: Calibrate spatial template distribution of light spots in an object space of the distance measurement system at an initial state, and spatial emission angle factors of the light spots.

For example, referring to FIG. 4, a calibration plate is placed at a fixed distance (for example, Depth=400 mm) in front of the distance measurement system, an emitter is controlled to project pulsed beams onto the calibration plate to form light spots, and an independent camera is used to photograph the calibration plate. An image processing method is used on the photographed image to automatically identify the light spots and number the light spots one by one, determine a spatial template position lattice (xᵢ, yᵢ, Depth) of the light spots in the object space (that is, position coordinates of each light spot on the calibration plate), and then calculate spatial emission angle factors (n_{x,i}, n_{y,i}, n_{z,i}) of each numbered light spot.

In some embodiments, the positions of the light spots can be obtained by restoring the photographed image. A relational expression of the spatial emission angle factors of the light spots and the position coordinates of the light spots is as follows:

$$\left\{\begin{matrix}{η}_{x , i} = \frac{{x}_{i}}{\sqrt{{x}_{i}^{2} + {y}_{i}^{2} + D e p t {h}^{2}}} , \\ {η}_{y , i} = \frac{{y}_{i}}{\sqrt{{x}_{i}^{2} + {y}_{i}^{2} + D e p t {h}^{2}}} , \\ {η}_{z , i} = \frac{D e p t h}{\sqrt{{x}_{i}^{2} + {y}_{i}^{2} + D e p t {h}^{2}}} , \\ D i s t a n c {e}_{i} = \sqrt{{x}_{i}^{2} + {y}_{i}^{2} + D e p t {h}^{2}}\end{matrix}\right) ,$$

where i is the serial number of the light spot. The definition of a coordinate system is shown in FIG. 4, (xᵢ, yᵢ, Depth) represents the position space coordinates of the light spots in the object space, and (n_{x,i}, n_{y,i}, n_{z,i}) represents spatial emission angle factors of the light spots with different serial numbers. Then a relationship between a time-of-flight distance Distanceᵢ and the position coordinates of the light spots in space satisfies:

$$\left\{\begin{matrix}{x}_{i} = {η}_{x , i} ⋅ d i s t a n c {e}_{i} , \\ {y}_{i} = {η}_{y , i} ⋅ d i s t a n c {e}_{i} , \\ D e p t h = {η}_{z , i} ⋅ d i s t a n c {e}_{i}\end{matrix}\right) .$$

According to a measured time-of-flight distance Distanceᵢ and calibrated spatial emission angle factors (nₓ,ᵢ, n_{y},ᵢ, n_{z,i}), position space coordinates (xᵢ, yᵢ, Depthᵢ) of the corresponding light spots can be calculated in real time.

In step S1, after each light spot is numbered, the serial numbers of the light spots and the spatial emission angle factors of the corresponding numbered light spots are stored, and a correspondence between the serial numbers of the light spots and the light sources of the emitter is established.

S2: Calculate coordinates of offset light spots on a pixel unit of a collector after impact deformation occurs in the distance measurement system, and obtain serial numbers of the offset light spots.

For example, after the impact deformation occurs in the distance measurement system in the actual use, calibrated spatial emission angle factors (nₓ,ᵢ, n_{y},ᵢ, n_{z,i}) cannot reflect the spatial positions of the offset light spots, and new spatial emission angle factors (n′_{x,i}, n′_{y,i}, ₙ′_{z,i}) need to be recalibrated. In addition, generally, the positions of the light spots on the pixel unit of the collector also offset. In this case, positions of activated pixels need to be corrected, so that enabled pixels can accurately collect a photonic signal in the reflected light spots, reduce the reception of ambient light received by excess enabled pixels, and enhance a signal-to-noise ratio of the signal reception.

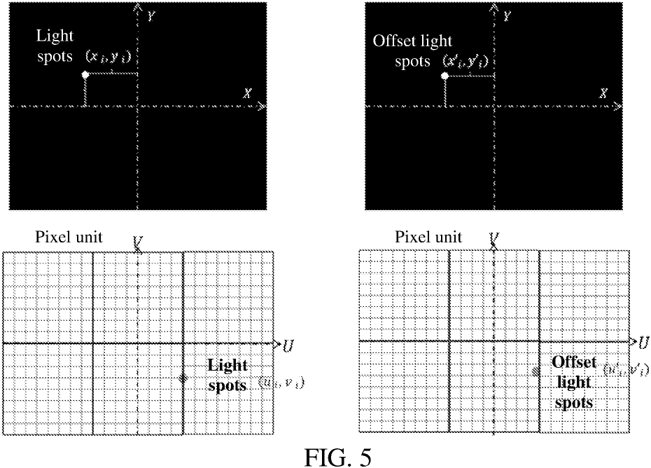

After the impact deformation occurs, referring to FIG. 5, the spatial template distribution of the light spots on the pixel unit of the collector changes. An automatic search mode of the light spots is used as an example for description. After the spatial template distribution of the light spots changes, the collector cannot normally obtain sufficient signals and start the automatic search mode of the light spots based on this. During the measurement process, the automatic search mode of the light spots is usually centered on the enabled pixels when no impact deformation occurs, a plurality of pixels around the enabled pixels are enabled sequentially, the pixels with a sufficient signal-to-noise ratio is detected and obtained, and the pixels with the sufficient signal-to-noise ratio are the corresponding pixels of the incident light spots after the impact deformation occurs. However, the enabled pixels after the impact deformation occurs and found by the automatic search mode are random and time-consuming, and only some of the pixels can be found. In order to obtain all the pixel positions that need to be enabled after the impact deformation occurs, the coordinates (u′ᵢ, v′ᵢ) of the offset light spots on the pixel unit need to be calculated to determine the positions of the offset light spots on the pixel unit after the impact deformation occurs.

In step S2, coordinates (u′ᵢ, v′ᵢ) of the offset light spots on the pixel unit are calculated according to the following formulas, where

$$\begin{matrix}{{u}^{′}}_{i} = \\ \frac{{R}_{10} + {R}_{11} {u}_{i} + {R}_{12} {v}_{i} + {R}_{13} {u}_{i} {v}_{i} + {R}_{14} {u}_{i} {}^{2} + {R}_{15} {v}_{i} {}^{2} + {R}_{16} {u}_{i} {}^{2} {v}_{i} + {R}_{17} {v}_{i} {}^{2} u + {R}_{18} {u}_{i} {}^{3} + {R}_{19} {v}_{i} {}^{3}}{{\left(1 + {R}_{31} {u}_{i} + {R}_{32} {v}_{i}\right)}^{3}}\end{matrix}$$

$$\begin{matrix}{{v}^{′}}_{i} = \\ \frac{{R}_{20} + {R}_{21} {u}_{i} + {R}_{22} {v}_{i} + {R}_{23} {u}_{i} {v}_{i} + {R}_{24} {u}_{i} {}^{2} + {R}_{25} {v}_{i} {}^{2} + {R}_{26} {u}_{i} {}^{2} {v}_{i} + {R}_{27} {v}_{i} {}^{2} u + {R}_{28} {u}_{i} {}^{3} + {R}_{29} {v}_{i} {}^{3}}{{\left(1 + {R}_{31} {u}_{i} + {R}_{32} {v}_{i}\right)}^{3}} ,\end{matrix}$$

where (uᵢ, vᵢ) are coordinates of the initial light spots before the impact deformation occurs, i is the serial number of the light spot, and Rₘₙ is a positional parameter. The positional parameter Rₘₙ can be calculated according to the above formula through a plurality of point pairs of correspondences between the offset light spots and the initial light spots (i takes different values). After the positional parameter Rₘₙ is determined, coordinates (uᵢ, vᵢ) of all the initial light spots are substituted into the above formula, and the coordinates (u′ᵢ, v′ᵢ) of all the offset light spots on the pixel unit can be obtained.

In some embodiments, a portion of the light sources of the emitter is controlled to be turned on (for example a column or a row), and the correspondence between the serial numbers of the light spots and the light sources can be obtained in step S1. That is, the serial numbers of the offset light spots can be determined according to the positions of the offset light spots on the pixel unit, thereby obtaining the serial numbers of the offset light spots.

S3: According to the coordinates of the offset light spots on the pixel unit and the serial numbers obtained in step S2, calibrate the distance measurement system in which the impact deformation occurs, to obtain new spatial emission angle factors (n′_{x,i}, n′_{y,i}, n′_{z,i}), so as to complete adaptive search of light spot positions.

For example, based on the position space coordinates (xᵢ, yᵢ, Depthᵢ) of the light spots and the coordinates (uᵢ, vᵢ) of the initial light spots in the object space of the distance measurement system at the initial state, a model of the correspondence between point pairs of the object space and the image space of the initial distance measurement system is obtained,

$$\begin{matrix}{x}_{i} = \\ \frac{{{R}^{′}}_{10} + {{R}^{′}}_{11} {u}_{i} + {{R}^{′}}_{12} {v}_{i} + {{R}^{′}}_{13} {u}_{i} {v}_{i} + {{R}^{′}}_{14} {u}_{i} {}^{2} + {{R}^{′}}_{15} {v}_{i} {}^{2} + {{R}^{′}}_{16} {u}_{i} {}^{2} {v}_{i} + {{R}^{′}}_{17} {v}_{i} {}^{2} u + {{R}^{′}}_{18} {u}_{i} {}^{3} + {{R}^{′}}_{19} {v}_{i} {}^{3}}{{\left(1 + {{R}^{′}}_{31} {u}_{i} + {{R}^{′}}_{32} {v}_{i}\right)}^{3}}\end{matrix}$$

$$\begin{matrix}{y}_{i} = \\ \frac{{{R}^{′}}_{20} + {{R}^{′}}_{21} {u}_{i} + {{R}^{′}}_{22} {v}_{i} + {{R}^{′}}_{23} {u}_{i} {v}_{i} + {{R}^{′}}_{24} {u}_{i} {}^{2} + {{R}^{′}}_{25} {v}_{i} {}^{2} + {{R}^{′}}_{26} {u}_{i} {}^{2} {v}_{i} + {{R}^{′}}_{27} {v}_{i} {}^{2} u + {{R}^{′}}_{28} {u}_{i} {}^{3} + {{R}^{′}}_{29} {v}_{i} {}^{3}}{{\left(1 + {{R}^{′}}_{31} {u}_{i} + {{R}^{′}}_{32} {v}_{i}\right)}^{3}} .\end{matrix}$$

The positional parameter R′ₘₙ of the above formula can be obtained through the correspondence of the plurality of point pairs (i takes different values, that is, different serial numbers), where m and n respectively represent different numerical subscripts. The coordinates (u′ᵢ, v′ᵢ) of the offset light spots on the pixel unit and the serial numbers of the light spots obtained in step S2 are substituted into the above formula of the determined positional parameter R′ₘₙ to obtain the position space coordinates (x′i, y′ᵢ, Depth′i) of all light spots in the object space after the impact deformation occurs, where

$$D \text{ept} {\text{h}}^{′} = {{x}^{′}}_{i}^{2} + {{y}^{′}}_{i}^{2} + D i s tan c {{e}^{′}}_{i}^{2} ,$$

and new spatial emission angle factors (n′_{x,i}, n′_{y},ᵢ, n′_{z},ᵢ) are obtained as:

$$\left\{\begin{matrix}{{η}^{′}}_{x , i} = \frac{{{x}^{′}}_{i}}{\sqrt{{{x}^{′}}_{i}^{2} + {{y}^{′}}_{i}^{2} + D e p t {{h}^{′}}^{2}}} , \\ {{η}^{′}}_{y , i} = \frac{{{y}^{′}}_{i}}{\sqrt{{{x}^{′}}_{i}^{2} + {{y}^{′}}_{i}^{2} + D e p t {{h}^{′}}^{2}}} , \\ {{η}^{′}}_{z , i} = \frac{D e p t {h}^{′}}{\sqrt{{{x}^{′}}_{i}^{2} + {{y}^{′}}_{i}^{2} + D e p t {{h}^{′}}^{2}}} , \\ D i s t a n c {{e}^{′}}_{i} = \sqrt{{{x}^{′}}_{i}^{2} + {{y}^{′}}_{i}^{2} + D e p t {{h}^{′}}^{2}}\end{matrix}\right) .$$

Based on the new spatial emission angle factors (n′ₓ,ᵢ, n′_{y},ᵢ, n′_{z},ᵢ) and the time-of-flight distance Distance′ᵢ measured by the distance measurement system after the impact deformation occurs, a point cloud can be restored accurately.

In some embodiments, according to the following model of the correspondence between the position space coordinates (xᵢ, yᵢ, Depthᵢ) of the light spots in the object space of the initial distance measurement system and the coordinates (uᵢ, vᵢ) of the initial light spots, the position space coordinates (x′i, y′ᵢ, Depth′ᵢ) of the light spots in the object space after the impact deformation occurs can be calculated to obtain the new spatial emission angle factors (n′ₓ,ᵢ, n′_{y},ᵢ, n′_{z},ᵢ), where

$$\left\{\begin{matrix}{u}_{i} = \frac{{{R}^{′}}_{10} {z}_{i}^{3} + {{R}^{′}}_{11} {x}_{i} {z}_{i}^{2} + {{R}^{′}}_{12} {y}_{i} {z}_{i}^{2} + {{R}^{′}}_{13} {x}_{i} {y}_{i} {z}_{i} + {{R}^{′}}_{14} {x}_{i}^{2} {z}_{i} + {{R}^{′}}_{15} {y}_{i}^{2} {z}_{i} + {{R}^{′}}_{16} {x}_{i}^{2} {y}_{i} + {{R}^{′}}_{17} {y}_{i}^{2} x + {{R}^{′}}_{18} {x}_{i}^{3} + {{R}^{′}}_{19} {y}_{i}^{3}}{{\left(1 + {{R}^{′}}_{31} {x}_{i} + {{R}^{′}}_{32} {y}_{i}\right)}^{3}} \\ {v}_{i} = \frac{{{R}^{′}}_{20} {z}_{i}^{3} + {{R}^{′}}_{21} {x}_{i} {z}_{i}^{2} + {{R}^{′}}_{22} {y}_{i} {z}_{i}^{2} + {{R}^{′}}_{23} {x}_{i} {y}_{i} {z}_{i} + {{R}^{′}}_{24} {x}_{i}^{2} {z}_{i} + {{R}^{′}}_{25} {y}_{i}^{2} {z}_{i} + {{R}^{′}}_{26} {x}_{i}^{2} {y}_{i} + {{R}^{′}}_{27} {y}_{i}^{2} x + {{R}^{′}}_{28} {x}_{i}^{3} + {{R}^{′}}_{29} {y}_{i}^{3}}{{\left(1 + {{R}^{′}}_{31} {x}_{i} + {{R}^{′}}_{32} {y}_{i}\right)}^{3}}\end{matrix}\right) ,$$

and zᵢ represents the position space coordinates (x′i, y′ᵢ, Depth′ᵢ) of the light spots in the object space after the impact deformation occurs.

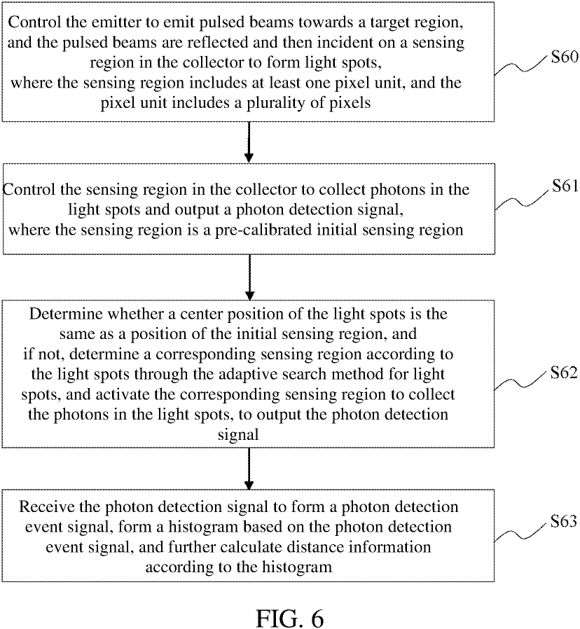

FIG. 6 shows a distance measurement method according to another embodiment of this application. The method includes the following steps.

S60: Control an emitter to emit pulsed beams towards a target region, and the pulsed beams are reflected and then incident on a sensing region in the collector to form light spots, where the sensing region includes at least one pixel unit, and the pixel unit includes a plurality of pixels.

S61: Control the sensing region in the collector to collect photons in the light spots and output a photon detection signal, where the sensing region is a pre-calibrated initial sensing region.

For example, an event that the pixels of the sensing region collect photons is regarded as occurrence of a photon detection event.

S62: Determine whether a center position of the light spots is the same as a position of the initial sensing region, and if not, determine a position of a corresponding sensing region according to the light spots through the adaptive search method for light spots according to any one of the foregoing embodiments, and activate the corresponding sensing region to collect the photons in the light spots, to output the photon detection signal.

S63: Receive the photon detection signal to form a photon detection event signal, form a histogram based on the photon detection event signal, and further calculate distance information according to the histogram.

This application further provides a computer-readable storage medium storing a computer program, and the program, when executed by a processor, implements the adaptive search method for light spots and the distance measurement method according to the solutions of the foregoing embodiments. The storage medium may be implemented by using any type of volatile or non-volatile storage device or a combination thereof.

Embodiments of this application may include or utilize a dedicated or general-purpose computer including computer hardware, as discussed in more detail below. Embodiments within the scope of this application also include physical and other computer-readable media for carrying or storing computer-executable instructions and/or data structures. The computer-readable storage medium may be any available medium that can be accessed by a general-purpose or special-purpose computer system. The computer-readable storage medium storing the computer-executable instructions is a physical storage medium. The computer-readable storage medium carrying the computer-executable instructions is a transmission medium. Therefore, for example, but not limitation, the embodiments of this application may include at least two different computer-readable media: a physical computer-readable storage medium and a transmission computer-readable storage medium.

An embodiment of this application further provides a computer device, including a memory, a processor, and a computer program stored in the memory and run on the processor, and the processor, when executing the computer program, implementing at least the adaptive search method for light spots and the distance measurement method according to the solutions of the foregoing embodiments.

It may be understood that, the foregoing contents are detailed descriptions of this application in conjunction with some embodiments, and the implementation of this application is not limited to these descriptions. A person of ordinary skill in the art, to which this application belong, may make various replacements or variations on the described implementations without departing from the principle of this application, and the replacements or variations should fall within the protection scope of this application. In the descriptions of this specification, descriptions using reference terms “an embodiment,” “some embodiments,” “an exemplary embodiment,” “an example,” “a specific example,” or “some examples” mean that characteristics, structures, materials, or features described with reference to the embodiment or example are included in at least one embodiment or example of this application.

In this specification, schematic descriptions of the foregoing terms are not necessarily directed at the same embodiment or example. Besides, the features, the structures, the materials or the characteristics that are described may be combined in proper manners in any one or more embodiments or examples. In addition, different embodiments or examples described this specification, as well as features of different embodiments or examples, may be integrated and combined by those skilled in the art without contradicting each other. Although the embodiments of this application and advantages thereof have been described in detail, it should be understood that various changes, substitutions, and alterations can be made herein without departing from the scope defined by the appended claims.

In addition, the scope of this application is not limited to the embodiments of the processes, machines, manufacturing, material composition, means, methods, and steps described in the specification. A person of ordinary skill in the art can easily understand and use the above disclosures, processes, machines, manufacturing, material composition, means, methods, and steps that currently exist or will be developed later and that perform substantially the same functions as the corresponding embodiments described herein or obtain substantially the same results as the embodiments described herein. Therefore, the appended claims include such processes, machines, manufacturing, material compositions, means, methods, or steps within the scope thereof.

What is claimed is:

1. A system for time-of-flight distance measurement, comprising:
an emitter, configured to project pulsed beams to a target region that are reflected by the target region to form light spots;
a collector, comprising a pixel unit comprising a plurality of pixels, and configured to receive the light spots; and
a processing circuit, synchronizing trigger signals of the emitter and the collector, and processing photonic signals in the light spots, to calculate distance information of a target in the target region, wherein
the collector further comprises a memory and a first processing circuit; the memory is configured to store serial numbers of the light spots during system calibration, and spatial emission angle factors of the light spots with different serial numbers; and the first processing circuit is configured to calculate coordinates of offset light spots after impact deformation occurs in the system, and obtain serial numbers of the offset light spots; and
the processing circuit calibrates the system after the impact deformation occurs, according to the coordinates of the offset light spots and the serial numbers of the offset light spots, to obtain new spatial emission angle factors.

2. The system according to claim 1, wherein the first processing circuit is configured to calculate the coordinates of the offset light spots after the impact deformation occurs according to the following formulas,
$$\begin{matrix}{{u}^{′}}_{i} = \\ \frac{{R}_{10} + {R}_{11} {u}_{i} + {R}_{12} {v}_{i} + {R}_{13} {u}_{i} {v}_{i} + {R}_{14} {u}_{i}^{2} + {R}_{15} {v}_{i}^{2} + {R}_{16} {u}_{i}^{2} {v}_{i} + {R}_{17} {v}_{i}^{2} u + {R}_{18} {u}_{i}^{3} + {R}_{19} {v}_{i}^{3}}{{\left(1 + {R}_{31} {u}_{i} + {R}_{32} {v}_{i}\right)}^{3}}\end{matrix}$$
$$\begin{matrix}{{v}^{′}}_{i} = \\ \frac{{R}_{20} + {R}_{21} {u}_{i} + {R}_{22} {v}_{i} + {R}_{23} {u}_{i} {v}_{i} + {R}_{24} {u}_{i}^{2} + {R}_{25} {v}_{i}^{2} + {R}_{26} {u}_{i}^{2} {v}_{i} + {R}_{27} {v}_{i}^{2} u + {R}_{28} {u}_{i}^{3} + {R}_{29} {v}_{i}^{3}}{{\left(1 + {R}_{31} {u}_{i} + {R}_{32} {v}_{i}\right)}^{3}}\end{matrix}$$
wherein (uᵢ, vᵢ) are coordinates of the light spots before the impact deformation occurs in the system, (u′i, v′ᵢ) are coordinates of the offset light spots after the impact deformation occurs, i is the serial numbers of the light spots or the offset light spots, Rₘₙ is a positional parameter, and m and n are integers.

3. The system according to claim 1, wherein the processing circuit is configured to turn on a portion of light sources of the emitter, and determine positions of offset light spots on the pixel unit, and the first processing circuit is configured to obtain serial numbers of the offset light spots on the pixel unit according to a correspondence between the serial numbers of the light spots and the light sources.

4. The system according to claim 3, wherein the processing circuit comprises a second processing circuit, configured to control a bias voltage of pixels corresponding to the positions of the offset light spots on the pixel unit, activate the pixels to collect photons in the offset light spots on the pixel unit, and to output a photon detection signal.

5. The system according to claim 3, wherein the light sources comprise a VCSEL array light source.

6. A method for search of light spot positions, comprising:
calibrating spatial template distribution of light spots in an object space of a distance measurement system and spatial emission angle factors of the light spots;
calculating coordinates of offset light spots on a pixel unit of a collector after impact deformation occurs in the distance measurement system, and obtaining serial numbers of the offset light spots; and
according to the coordinates of the offset light spots on the pixel unit of the collector and the serial numbers, calibrating the distance measurement system after the impact deformation occurs to obtain new spatial emission angle factors, and completing the search of light spot positions.

7. The method according to claim 6, wherein
the calibrating the spatial template distribution of the light spots comprises placing a calibration plate in front of the distance measurement system, controlling an emitter to project pulsed beams onto the calibration plate that are reflected by the calibration plate to form the light spots, and photographing the calibration plate using a camera, and
the method further comprises identifying and numbering the light spots, and calculating the spatial emission angle factors of the light spots with different serial numbers and the spatial template distribution of the light spots in the object space.

8. The method according to claim 6, wherein the calculating the coordinates of the offset light spots on the pixel unit of the collector according to the following formulas,
$$\begin{matrix}{{u}^{′}}_{i} = \\ \frac{{R}_{10} + {R}_{11} {u}_{i} + {R}_{12} {v}_{i} + {R}_{13} {u}_{i} {v}_{i} + {R}_{14} {u}_{i}^{2} + {R}_{15} {v}_{i}^{2} + {R}_{16} {u}_{i}^{2} {v}_{i} + {R}_{17} {v}_{i}^{2} u + {R}_{18} {u}_{i}^{3} + {R}_{19} {v}_{i}^{3}}{{\left(1 + {R}_{31} {u}_{i} + {R}_{32} {v}_{i}\right)}^{3}}\end{matrix}$$
$$\begin{matrix}{{v}^{′}}_{i} = \\ \frac{{R}_{20} + {R}_{21} {u}_{i} + {R}_{22} {v}_{i} + {R}_{23} {u}_{i} {v}_{i} + {R}_{24} {u}_{i}^{2} + {R}_{25} {v}_{i}^{2} + {R}_{26} {u}_{i}^{2} {v}_{i} + {R}_{27} {v}_{i}^{2} u + {R}_{28} {u}_{i}^{3} + {R}_{29} {v}_{i}^{3}}{{\left(1 + {R}_{31} {u}_{i} + {R}_{32} {v}_{i}\right)}^{3}}\end{matrix}$$
wherein (uᵢ, vᵢ) are coordinates of the light spots before the impact deformation occurs, (u′ᵢ, v′ᵢ) are coordinates of the offset light spots after the impact deformation occurs, i is the serial number of the light spots or the offset light spots, Rₘₙ is a positional parameter, and m and n are integers.

9. The method according to claim 7, wherein the calculating the coordinates of the offset light spots comprises: turning on a portion of light sources of the emitter, determining coordinates of the offset light spots on the pixel unit, obtaining the serial numbers of the offset light spots according to a correspondence between the serial numbers of the light spots and the light sources.

10. A method for distance measurement, comprising:
controlling an emitter to emit pulsed beams towards a target region, and a portion of the pulsed beams is reflected and incident on a sensing region in a collector to form light spots, wherein the sensing region comprises at least one pixel unit, and the pixel unit comprises a plurality of pixels;
controlling the sensing region in the collector to collect photons in the light spots and output a photon detection signal, wherein the sensing region is a pre-calibrated initial sensing region;
determining whether a center position of the light spots is the same as a position of the pre-calibrated initial sensing region, and if determining that the center position of the light spots is not the same as the position of the initial sensing region, determining a position of a second sensing region corresponding to the light spots through the method according to claim 6, and activating the second sensing region to collect the photons in the light spots to output the photon detection signal; and
receiving the photon detection signal to form a photon detection event signal, forming a histogram based on the photon detection event signal, and calculating distance information according to the histogram.
